(19) United States
(12) Patent Application Publication
(10) Pub. No.: US 2012/0250062 A1
(43) Pub. Date: Oct. 4, 2012

(54) PRINTING DEVICE FOR PRODUCING FINISHED PRODUCT BY ONE-PASS SHEET-FEED AND OPERATION METHOD OF THE SAME

(75) Inventors: Yuxin Wang, Tianjin (CN); Yunfei Shou, Tianjin (CN); Zhangbo Peng, Tianjin (CN); Xiaoling Dong, Tianjin (CN)

(73) Assignee: MASTERWORK MACHINERY CO., LTD, Tianjin (CN)

(21) Appl. No.: 13/516,416

(22) PCT Filed: Dec. 22, 2010
(86) PCT No.: PCT/CN2010/002127

§ 371 Date: Jun. 15, 2012

(30) Foreign Application Priority Data
Dec. 23, 2009 (CN) 200910245043.5

(51) Int. Cl. G06K 15/02

(52) U.S. Cl. 358/1.13

(57) ABSTRACT

A printing device for producing finished product by one-pass sheet-feed may include a sheet-conveying unit, stamping-control units, a die-cutting unit, a waste edges removing unit, a blanking unit, a waste removing unit, and a conveying mechanism. The operation method of the device may include transferring a single sheet to the stamping-control units by the sheet-conveying unit, gripping and transferring the sheet to the stamping-control units by a gripper bar, to stamp or indent; transferring the sheet to the die-cutting unit to complete the die-cutting work; transferring the sheet to the waste edges removing unit to remove part of the waste edges; transferring the sheet to the blanking unit to collect all finished product; and transferring the last remaining waste edges to the waste removing unit.

### CROSS REFERENCE TO RELATED APPLICATIONS

This is a U.S. national stage of International Application No. PCT/CN2010/002127, filed on Dec. 22, 2010. Priority under 35 U.S.C. §119(a) and 35 U.S.C. §365(b) is claimed from Chinese Application No. 200910245043.5, filed Dec. 23, 2009, the disclosure of which is also incorporated herein by reference.

### TECHNICAL FIELD

The present invention relates to an automated printing device and operation method of the same, especially relates to a printing device that completes all processing operations and gets the finished product (blanks) by one-pass sheet-feed (single material) and the operation method of the same.

### BACKGROUND

With the rapid development of the printing and packaging industry, the market is increasingly demanding in the degree of automation of the processing equipment after printing. In order to predominate in market shares, the pursuit of fast and accurate processing equipment to improve production efficiency is an inevitable trend of market demand and the development of the equipment after printing.

The available multiple unit die-cutting stamping equipment in the market (see the Company's application for patent of ZL 200410093700.6) uses the molding unit and aluminum foil control unit in the multiple units to complete the required multiple stamping (or indentation) and die-cutting operations. However, it only has a simple waste edges removing function and cannot completely remove the waste edges, and blanks after die cutting are not able to be collected to finished product. After processing with this equipment, extra manual labor is needed to remove the remaining waste edges. This is not only inefficient, but also makes it easy to tear the finished product, thereby resulting in the increase of defect product. Obviously, this type of the equipment cannot satisfy the market need of obtaining the finished product in single sheet-feeding process.

Another blanking die-cutting device available in the market uses semi-finished product that has completed the stamping (or indentation) in the other equipment to continue the die-cutting, waste edges removing, blanking and waste removing operation to obtain the finished product (blanks). Obviously, this type of the equipment also cannot satisfy the market need of obtaining the finished product in single sheet-feeding process.

To sum up, the existing technology in the market cannot have the function of achieving the stamping (once or twice), die-cutting, waste edges removing, blanking, waste removing on the same device to get the finished products (blanks). The market is in urgent need for multi-unit die-cutting stamping equipment having the blanking function to improve production efficiency.

### SUMMARY OF THE INVENTION

At least an embodiment of a printing device for producing finished product by one-pass sheet-feed may include a sheet-conveying unit, a stamping-control unit, a die-cutting unit, a waste edges removing unit, a blanking unit, a waste removing unit, and a conveying mechanism. An output end of the sheet-conveying unit may connect with an input end of the stamping-control unit. The stamping-control unit, the die-cutting unit, the waste edges removing unit, the blanking unit and the waste removing unit may be sequentially connected in series, and an output end and an input end of adjacent units may be connected with each other. The conveying mechanism may be configured to transfer a sheet to each unit through the stamping-control unit, the die-cutting unit, the waste edges removing unit, the blanking unit and the waste removing unit.

At least an embodiment of an operation method of a printing device for producing finished product by one-pass sheet-feed may include:
(1) transferring a single sheet to an entrance of a stamping-control unit by a sheet-conveying unit, then after orientation, gripping the sheet that is conveyed in place by a gripper bar on a gripper bar chain of a conveying mechanism;
(2) transferring the sheet to a processing position of the stamping-control unit by the gripper bar on the gripper bar chain, to stamp or indent in order;
(3) transferring the stamped or indented sheet to a die-cutting unit by the gripper bar on the gripper bar chain, to die-cut it into box shape;
(4) transferring the die-cut sheet to a waste edges removing unit by the gripper bar on the gripper bar chain, to remove part of waste edges in this unit;
(5) transferring the sheet that has removed part of the waste edges to a blanking unit, to collect all the finished products in piles and obtain neatly arranged finished product; and
(6) gripping and transferring the last remaining waste edges to a waste removing unit by the gripper bar, and the waste edges being transferred out through the conveyer belt of the waste removing unit.

According to at least an embodiment of the present invention, the operations on multiple devices are integrated into a single device, thereby reducing the number of sheet feeding, and the production efficiency being improved more than doubled.

According to at least an embodiment of the present invention, because of the integration of multiple devices to one device, the number of operators is reduced. For example, to accomplish the same processing operations, it needs at least four operators if using two existing devices; it only needs 2-3 operators if using the device of the present invention. Therefore, labor costs are reduced.

In the prior art, when processing on multiple devices, the sheet is easy to deform after stamping due to the paper temperature from high temperature to room temperature, resulting in reduced accuracy in blanking process that is performed after some time. At least an embodiment of present invention can complete all the processes within 1 second on a single device. Thus it not only eliminates deformation caused by sheet temperature, but also avoids low accuracy caused by the repeated orientation of multiple sheet-feeding processes. It improves the processing quality, reduces waste product and the loss.

### DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is the structural diagram of the printing device for producing finished product by one-pass sheet-feed in accordance with at least an embodiment of the present invention.

### DETAILED DESCRIPTION OF THE EMBODIMENT

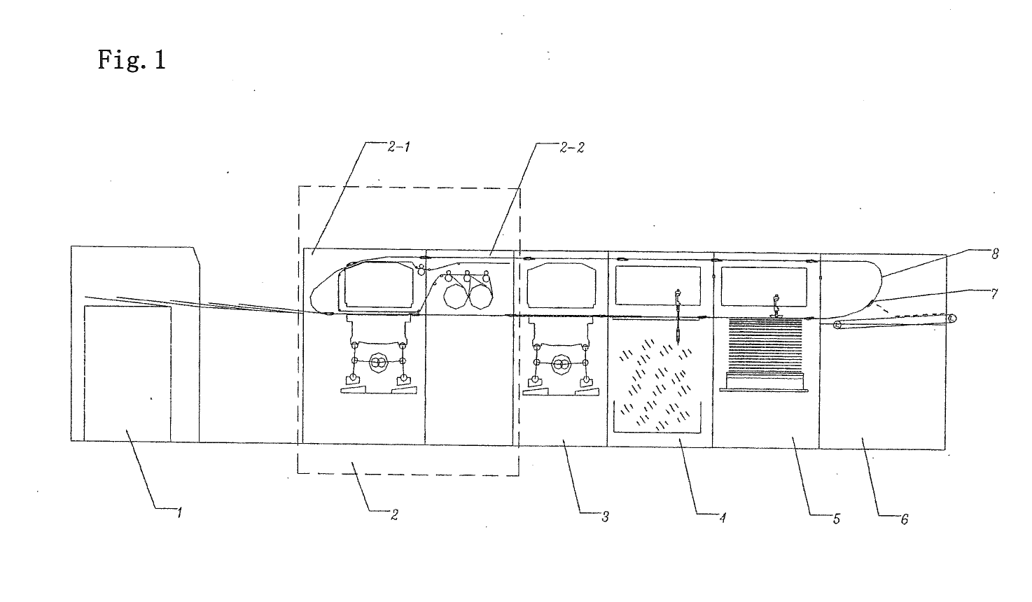

FIG. 1 is the structural diagram of the printing device for producing finished product by one-pass sheet-feed in accordance with at least an embodiment of the present invention.

The printing device for producing finished product by one-pass sheet-feed in accordance with at least an embodiment of the present invention comprises a sheet-conveying unit 1, at least one stamping-control unit 2, a die-cutting unit 3, a waste edges removing unit 4, a blanking unit 5, a waste removing unit 6, a gripper bar 7, a gripper bar chain 8. The output end of the sheet-conveying unit 1 connects with the input end of the stamping-control unit 2. Stamping-control unit 2, die-cutting unit 3, waste edges removing unit 4, blanking unit 5 and waste removing unit 6 are sequentially connected with each other in series and the output end and the input end adjacent two units are connected together. The conveying mechanism comprises the gripper bar chain 8 and one or many gripper bars 7. The gripper bars 7 are fixed on the gripper bar chain 8 which forms a closed loop through the stamping-control unit 2, the die-cutting unit 3, the waste edges removing unit 4, the blanking unit 5, the waste removing unit 6, and is driven by the power mechanism. When the sheet-conveying unit 1 transfers a sheet to the entrance of the stamping-control unit 2, the gripper bar 7 grips the sheet and sequentially transfers it to the stamping-control unit 2, the die-cutting unit 3, the waste edges removing unit 4, the blanking unit 5, the waste removing unit 6. The gripper bar 7 circularly moves with the movement of the conveying chain. The conveying mechanism is an intermittent driving mechanism which drives the gripper bar to alternately move and stop, and is synchronized with the reciprocated movement frequency of the fixed platform and the moving platform in each group.

The stamping-control unit 2 comprises the molding unit 2-1 and the aluminum foil control unit 2-2; and the molding unit 2-1 and the aluminum foil control unit 2-2 are in turn connected between the sheet-conveying unit 1 and the die-cutting unit 3.

The fixed platform and the moving platform of the molding unit 2-1 are equipped with the indentation tools or the stamping tools.

The molding unit 2-1 has forms of plate pressing, round pressing, and flatbed cylinder pressing.

The stamping-control unit 2 may be one or more. Two or more stamping-control units 2 has synchronous conveying mechanisms between their molding units 2-1, and the synchronous conveying mechanism is also provided between stamping-control unit 2 and the die-cutting unit 3. The output ends of the second and subsequent stamping-control unit 2 and die-cutting unit 3 are provided with gripper bar orientation devices, which are used to position gripper bar in the direction of the sheet-feeding and lateral direction before processing the sheet. Each of the gripper bar orientation devices comprises an orientation block, the gripper bar chain, a gripper bar, chain rollers, and an orientation pendulum. The orientation block is inserted between the two chain rollers with its orientation surface abut on the chain rollers, which acts on the orientation function to the gripper bars, thus it avoids that the stretch of the gripper bar chain effects on the accuracy of orientation, and ensures the accuracy of the sheet processing.

The sheet-conveying unit 1 conveys a single sheet, and it conveys the sheet to the position where the gripper bar may grip. The fixed platform and moving platform of the die-cutting unit 3 are equipped with die-cutting tools. Die-cutting unit 3 has forms of plate pressing, round pressing, and flatbed cylinder pressing. An orientation device for the chain is provided on the position of rear orientation of the die-cutting unit 3.

The following explains at least an embodiment of the operation methods of the print device for producing finished product by one-pass sheet-feed.

The operation method of the printing device for producing finished product by one-pass sheet-feed comprises the following steps:

(1) The sheet-conveying unit 1 conveys a single sheet to the entrance of the stamping-control unit 2, then after orientation, the gripper bar 7 on the gripper bar chain 8 grips the sheet that is conveyed in place;

(2) The gripper bar 7 on the gripper bar chain 8 delivers the sheet to the processing position of the stamping-control unit, to perform stamping or indentation in order;

(3) stamped or indented sheet is conveyed to the die-cutting unit 3 by the gripper bar 7 on the gripper bar chain 8, to die-cut stamped or indented sheet into box shape;

(4) The die-cut sheet is conveyed to the waste edges removing unit 4 by the gripper bar 7, to remove part of the waste edges by upper and lower needles in this unit;

(5) The waste edges removed sheet is transferred by the gripper bar 7 to the blanking unit 5, to press and collect in piles the finished products, and get the neatly arranged finished products;

(6) The gripper bar 7 grips and delivers the last remaining waste edges to the waste removing unit 6, and the waste edges are transferred out through the conveyer belt.

In addition, the finished products in step (5) are blanks.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A printing device for producing finished product by one-pass sheet-feed comprising;
a sheet-conveying unit,
a stamping-control unit,
a die-cutting unit,
a waste edges removing unit,
a blanking unit,
a waste removing unit, and
a conveying mechanism,
wherein an output end of the sheet-conveying unit connects with an input end of the stamping-control unit;
the stamping-control unit, the die-cutting unit, the waste edges removing unit, the blanking unit and the waste removing unit are sequentially connected in series, and an output end and an input end of adjacent units are connected with each other, and
the conveying mechanism is configured to transfer a sheet to each unit through the stamping-control unit, the die-cutting unit, the waste edges removing unit, the blanking unit and the waste removing unit.

2. The printing device for producing finished product by one-pass sheet-feed according to claim 1, wherein the stamping-control unit comprises:
a molding unit; and
an aluminum foil control unit;
wherein the molding unit and the aluminum foil control unit are connected in order between the sheet-conveying unit and the die-cutting unit.

3. The printing device for producing finished product by one-pass sheet-feed according to claim 2, wherein the molding unit comprises:
a fixed platform; and
a moving platform; and
the fixed platform and the moving platform are equipped with indentation tools or a stamping tools.

4. The printing device for producing finished product by one-pass sheet-feed according to claim 2, wherein the molding unit has forms of flat pressing, round pressing, and flatbed cylinder pressing.

5. The printing device for producing finished product by one-pass sheet-feed according to claim 1, wherein the printing device has at least one stamping-control unit.

6. The printing device for producing finished product by one-pass sheet-feed according to claim 5, wherein the printing device has two or more stamping control units, the two or more stamping control units has a synchronous conveying mechanism between each molding units, and the synchronous conveying mechanism is also disposed between the stamping-control unit and the die-cutting unit.

7. The printing device for producing finished product by one-pass sheet-feed according to claim 6, wherein the output ends of the second and subsequent stamping-control units and the die-cutting unit are provided with gripper bar orientation devices.

8. The printing device for producing finished product by one-pass sheet-feed according to claim 5, wherein the conveying mechanism comprises:
a gripper bar; and
a gripper bar chain,
wherein the sheet-conveying unit transfers a single sheet to the position where the gripper bar may grip the sheet.

9. The printing device for producing finished product by one-pass sheet-feed according to claim 8, further comprising one or more gripper bars, and the one or more gripper bars are fixed on the gripper bar chain.

10. The printing device for producing finished product by one-pass sheet-feed according to claim 1, wherein the fixed platform and the moving platform of the die-cutting unit are provided with the indentation tools or the stamping tools.

11. The printing device for producing finished product by one-pass sheet-feed according to claim 5, wherein the die-cutting unit has forms of flat pressing, round pressing, and flatbed cylinder pressing.

12. An operation method of a printing device for producing finished product by one-pass sheet-feed comprising:
(1) transferring a single sheet to an entrance of a stamping-control unit by a sheet-conveying unit, then after orientation, gripping the sheet that is conveyed in place by a gripper bar on a gripper bar chain of a conveying mechanism;
(2) transferring the sheet to a processing position of the stamping-control unit by the gripper bar on the gripper bar chain, to stamp or indent in order;
(3) transferring the stamped or indented sheet to a die-cutting unit by the gripper bar on the gripper bar chain, to die-cut it into box shape;
(4) transferring the die-cut sheet to a waste edges removing unit by the gripper bar on the gripper bar chain, to remove part of waste edges in this unit;
(5) transferring the sheet that has removed part of the waste edges to a blanking unit, to collect all the finished products in piles and obtain neatly arranged finished product; and
(6) gripping and transferring the last remaining waste edges to a waste removing unit by the gripper bar, and the waste edges being transferred out through the conveyer belt of the waste removing unit.

13. The operation method of a printing device for producing finished product by one-pass sheet-feed according to claim 12, wherein the finished product in the step (5) is blanks.
